(19) United States
(12) Patent Application Publication
(10) Pub. No.: US 2009/0296279 A1
(43) Pub. Date: Dec. 3, 2009

(54) MAGNETIC RECORDING MEDIUM AND INFORMATION RECORDING DEVICE

(75) Inventors: Nobutaka Ihara, Kawasaki (JP); Hiroto Takeshita, Kawasaki (JP); Yuji Ito, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/404,131

(22) Filed: Mar. 13, 2009

(30) Foreign Application Priority Data
Jun. 2, 2008 (JP) 2008-144511

(51) Int. Cl. G11B 5/82

(52) U.S. Cl. 360/135; G9B/5.293

(57) ABSTRACT

A magnetic recording medium including: a substrate; plural information recording members that are formed of a hard magnetic material on the substrate, in each of which magnetization in a direction crossing the substrate is generated and, when the information recording members pass in a predetermined traveling direction in a magnetic field for information recording, the magnetization is directed to a direction corresponding to a direction of the magnetic field and information is recorded; and a high-permeability film that is placed on an edge on a front side of the information recording members in the traveling direction and has a magnetic permeability higher than a magnetic permeability of the information recording members.

### CROSS-REFERENCE TO RELATED APPLICATION

This application is based upon and claims the benefit of priority of the prior Japanese Patent Application No. 2008-144511, filed on Jun. 2, 2008, the entire contents of which are incorporated herein by reference.

### FIELD

The embodiment discussed herein is related to a magnetic recording medium in which information is recorded according to a direction of magnetization in a magnetic material and an information recording device that records information using such a magnetic recording medium.

### BACKGROUND

In the field of computer, a large amount of information is commonly treated. As one of devices that record vast amounts of information, a hard disk device (HDD) is used. The HDD is an information recording device incorporating a magnetic disk as a disc-shaped magnetic medium in which information is recorded.

In recent years, as a technique for remarkably improving recording density of recording media, a so-called bit patterned medium attracts attention (see, for example, Japanese Laid-open Patent Publication No. 2005-317155 and Japanese Laid-open Patent Publication No. 2006-40321). In the bit patterned medium, a large number of recording bits as micro magnetic material in nanometer order are arrayed on a substrate. In most cases, a vertical magnetic recording system for recording information in the direction of magnetization orthogonal to the substrate is adopted as an information recording system.

As one of phenomena that prevent long-term storage of information recorded in a magnetic disk, there is a phenomenon called thermal fluctuation. The thermal fluctuation is a phenomenon in which a direction of magnetization becomes unstable because of the influence of external thermal energy. The thermal fluctuation more conspicuously appears as the size of a magnetic domain in which the magnetization is stored becomes smaller. In the bit patterned medium, the respective recording bits play a role of the magnetic domain. However, since the recording bits are formed in a very small size for improvement of recording density, the problem of the thermal fluctuation tends to be manifest.

In the past, in the bit patterned medium, in order to impart sufficient resistance against such thermal fluctuation, the respective recording bits are often formed of a magnetic material with improved magnetic anisotropy having the direction orthogonal to the substrate as an easy axis of magnetization. The recording bits formed of such a magnetic material having high magnetic anisotropy require large energy for reversal of magnetization. Therefore, the recording bits have sufficient resistance against the thermal fluctuation.

However, the energy required for reversal of magnetization being large in the respective recording bits means that, on the other hand, it is difficult to reverse magnetization of the respective recording bits in information recording. Therefore, in the bit patterned medium having such recording bits, a write error causing a failure in reversal of magnetization tends to occur during recording of information.

In a HDD including the bit patterned medium as the magnetic disk, during recording of information, a recording head that records the information applies a magnetic field for information recording to each of recording bits that sequentially pass right below the recording head according to the rotation of the magnetic disk. The information is recorded in the respective recording bits such that the direction of magnetization is changed to a direction corresponding to the direction of the magnetic field through which the recording bits pass.

The application of the magnetic field by the recording head to the recording bits as recording targets is executed at timing when the recording bits as the recording targets pass right below the recording head. In recent years, intervals among recording bits are reduced in order to improve recording density of information in the HDD. A range of the timing when the application of the magnetic field is possible is being narrowed. As a result, for example, because of slight rotation unevenness of the magnetic disk, the timing of the application of the magnetic field by the recording head often deviates from the range.

In such a case, if the timing of the application of the magnetic field is earlier than the range, information is likely to be overwritten on the information-recorded recording bits in which information is recorded right before the recording bits as the recording targets. In most bit pattern media, since the large magnetic field may be necessary for reversal of magnetization as explained above, even if the timing of the application of the magnetic field is too early, such overwriting can be suppressed to a certain degree. On the other hand, when the timing of the application of the magnetic field is later than the range, the reversal of magnetization is likely to end in failure because of insufficiency of the strength of the magnetic field to cause a write error. In this case, since the large magnetic field may be necessary for reversal of magnetization, as opposed to the case in which the timing of the application is too early, it is difficult to suppress such a write error.

### SUMMARY

According to an aspect of the invention, a basic mode of a magnetic recording medium includes:

a substrate;

plural information recording members that are formed of a hard magnetic material on the substrate, in each of which magnetization in a direction crossing the substrate is generated and, when the information recording members pass in a predetermined traveling direction in a magnetic field for information recording, the magnetization is directed to a direction corresponding to a direction of the magnetic field and information is recorded; and

a high-permeability film that is placed on an edge on a front side of the information recording members in the traveling direction and has a magnetic permeability higher than a magnetic permeability of the information recording members.

The basic mode of the magnetic recording medium is a bit patterned medium that includes plural information recording members in which information is recorded in the direction of magnetization orthogonal to the substrate, the information being recorded in a vertical magnetic recording system. According to the basic mode of the magnetic recording medium, the high-permeability magnetic film is placed on the edge on the front side of the respective information recording members in the traveling direction. Therefore, a part of magnetic lines of force among magnetic lines of force in the magnetic field for information recording, which are expected to pass the front of the information recording members unless the high-permeability magnetic film is not present are absorbed by the high-permeability magnetic film and pass through the information recording members. Consequently, the number of magnetic lines of force that pass through the information recording members increases and the strength of the magnetic field that contributes to reversal of magnetization increases. According to the basic mode of the magnetic recording medium, magnetic lines of force led into the information recording members by the high-permeability magnetic film pass through the information recording members obliquely to magnetization in the direction orthogonal to the substrate. The magnetic lines of force that pass obliquely to magnetization have a large effect of reversing the magnetization because the magnetic lines of force act to push the magnetization in the direction along the substrate and reverse the magnetization. In this way, according to the basic mode of the magnetic recording medium, the strength of the magnetic field that contributes to reversal of magnetization increases. Further, since the magnetic lines of force passing through the information recording members have the large effect of reversing magnetization, the occurrence of a write error causing a failure in reversal of magnetization is suppressed. Moreover, according to the basic mode of the magnetic recording medium, with the effect of absorption of magnetic lines of force by the high-permeability magnetic film, the magnetic lines of force can be led to the information recording members even if the information recording members as recording targets separate from the recording head to a certain extent. Consequently, a range of timing when the recording head can apply a magnetic field to the information recording members as recording targets is extended because of the effect of absorption of the magnetic lines of force. As a result, the occurrence of a delay in application timing of a magnetic field that induces a write error due to insufficiency of the strength of the magnetic field can be suppressed.

### BRIEF DESCRIPTION OF DRAWINGS

FIG. 1A and FIG. 1B are diagrams of a hard disk device (HDD) as a specific embodiment of the information recording device;

FIG. 2A and FIG. 2B are detailed diagrams of the recording bit and the soft high-permeability magnetic film illustrated in FIG. 1B;

FIG. 3 is a schematic diagram of a state in which magnetic lines of force of a magnetic field applied by the recording head are absorbed by the soft high-permeability magnetic film;

FIG. 4 is a diagram of a series of work from step S1 to step S5 of the method of manufacturing the magnetic disk;

FIG. 5 is a diagram of a series of work from step S6 to step S10 of the method of manufacturing the magnetic disk; and

FIG. 6 is a diagram of a state in which the second mask is formed on the surface of the disk substrate covered with the NiFe film.

### DESCRIPTION OF EMBODIMENTS

Specific embodiments of the magnetic recording medium and the information recording device explained about the basic modes are explained below with reference to the accompanying drawings.

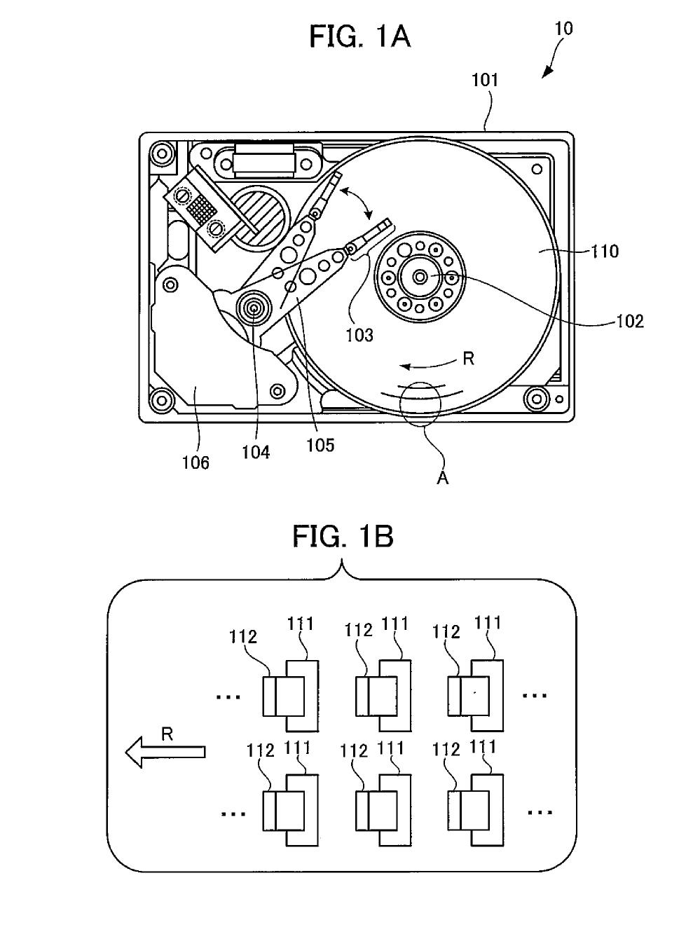

FIG. 1A and FIG. 1B are diagrams of a hard disk device (HDD) as a specific embodiment of the information recording device.

In FIG. 1A, a HDD 10 is illustrated. In FIG. 1B, an enlarged diagram of an area A in FIG. 1A is illustrated.

A housing 101 of the HDD 10 illustrated in FIG. 1A houses a magnetic disk 110 that is attached to a rotating shaft 102 and rotates in a rotating direction indicated by an arrow R, a head gimbal assembly 103 that includes at its end a recording head for recording information on the magnetic disk 110 and a reproducing head for reproducing information from the magnetic disk 110, a carriage arm 105 that moves, with the head gimbal assembly 103 fastened thereto, along the surface of the magnetic disk 110 around an arm shaft 104, and an arm actuator 106 that drives the carriage arm 105. The magnetic disk 110 housed in the HDD 10 is a specific embodiment of the magnetic recording medium explained about the basic mode.

The magnetic disk 110 is a bit patterned medium in which plural tracks are formed by concentrically arraying, on a disk substrate made of a nonmagnetic material, plural recording bits 111 having recording layers explained later that play a role of a magnetic domain for storing magnetization.

When information is recorded in the magnetic disk 110 or information recorded in the magnetic disk 110 is reproduced, the carriage arm 105 is driven by the arm actuator 106 and the recording head or the reproducing head is positioned in a desired track on the rotating magnetic disk 110. The recording head or the reproducing head sequentially approaches the large number of recording bits 111 arranged in the respective tracks of the magnetic disk 110 according to the rotation of the magnetic disk 110. During the recording of the information, an electric recording signal is inputted to the recording head that approaches the recording bits 111 in this way. A magnetic field is applied to the respective recording bits 111 by the recording head according to the recording signal. Information carried by the recording signal is recorded in the recording layers of the recording bits 111 as the direction of magnetization explained later. During the reproduction of the information, the information recorded in the recording layers of the respective recording bits 111 is extracted by the reproducing head as an electric reproduction signal corresponding to the direction of a magnetic field generated by the magnetization of the respective recording bits 111.

In this embodiment, as illustrated in FIG. 1B, edges on front sides of the respective recording bits 111 in the rotating direction of the magnetic disk 110 indicated by the arrow R, i.e., a traveling direction of the recording bits 111 and sides on the front side are covered with a soft high-permeability magnetic film 112 with the thickness of 7 nm formed of NiFe as a soft magnetic material. In general, the soft magnetic material has high magnetic permeability. Therefore, in this embodiment, the soft high-permeability magnetic film 112 having magnetic permeability higher than that of the recording bits 111 formed of a hard magnetic material as explained later is easily realized by using the soft magnetic material.

This means that an application mode “the high-permeability magnetic film is formed of a soft magnetic material” is preferable to the basic modes of the magnetic recording medium and the information recording device.

The soft high-permeability magnetic film 112 is an example of the high-permeability magnetic film in the basic mode and this application mode.

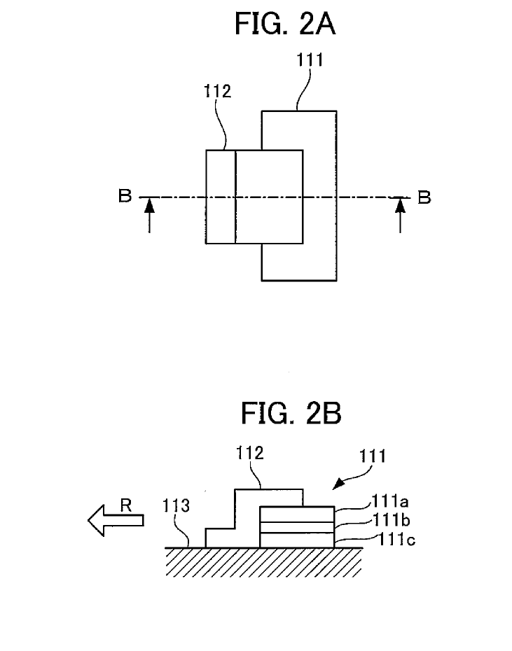

FIG. 2A and FIG. 2B are detailed diagrams of the recording bit and the soft high-permeability magnetic film illustrated in FIG. 1B.

In FIG. 2A, a top view of the recording bit 111 and the soft high-permeability magnetic film 112 illustrated in FIG. 1A as well is illustrated. In FIG. 2B, a sectional view taken along a cut line B-B illustrated in FIG. 2A of the recording bit 111 and the soft high-permeability magnetic film 112 is illustrated.

As illustrated in FIG. 2B, the recording bit 111 has the structure in which a soft magnetic backing layer 111c with the thickness of 50 nm made of a soft magnetic material, an intermediate layer 111b with the thickness of 10 nm made of a nonmagnetic material, and a recording layer 111a with the thickness of 15 nm made of a Co alloy as a hard magnetic material are stacked in this order from the side of the disk substrate 113 formed of glass as a nonmagnetic material.

An application mode “the information recording members have a recording layer formed of an alloy containing any of Co, Fe, Ni, Pt, Cr, B, Ti, and Ta” is preferable to the basic mode.

According to this preferred application mode, it is possible to obtain satisfactory information recording members having high holding power by using the alloy.

The disk substrate 113 is an example of the substrate in the basic mode. The recording bit 111 is an example of the information recording members in the basic mode and the application mode. The recording layer 111a is an example of the recording layers in the application mode.

The hard magnetic material forming the recording layer 111a has strong magnetic anisotropy having a direction perpendicular to the disk substrate 113 as easy axis of magnetization. As a result, in the recording layer 111a, magnetization faces a direction perpendicular to the disk substrate 113. Since the magnetization is oriented in any one of an upward direction and a downward direction in FIG. 2, information is recorded in the recording layer 111a. In this way, the magnetic disk 110 illustrated in FIG. 1 is a media of a so-called vertical magnetic recording system in which information is recorded in the respective recording bits 111 according to the direction of magnetization perpendicular to the disk substrate 113. Since the magnetic anisotropy of the hard magnetic material forming the recording layer 11a is strong as explained above, magnetization facing the upward direction or the downward direction has strong resistance against so-called thermal fluctuation.

Further, in this embodiment, as explained above, the edges and the sides on the front side in the traveling direction indicated by the arrow R of the respective recording bits 111 are covered with the soft high-permeability magnetic film 112. The soft high-permeability magnetic film 112 has magnetic permeability higher than that of the recording layer 111a. As a result, magnetic lines of force of a magnetic field applied by the recording head are about to actively pass through the soft high-permeability magnetic film 112. In other words, in this embodiment, the magnetic lines of force of the magnetic field applied by the recording head are absorbed by the soft high-permeability magnetic film 112.

In this embodiment, the soft high-permeability magnetic film 112 covers the edge and the side in the recording bit 111 as explained above. Therefore, most of the magnetic lines of force of the magnetic field applied by the recording head are absorbed by both the edge and the side and led to the recording layer 111a.

This means that an application mode “a side surface on the front side of the information recording members in the traveling direction is also covered with the high-permeability magnetic film” is preferable to the basic mode.

The soft high-permeability magnetic film 112 is an example of the high-permeability magnetic film in this application mode as well.

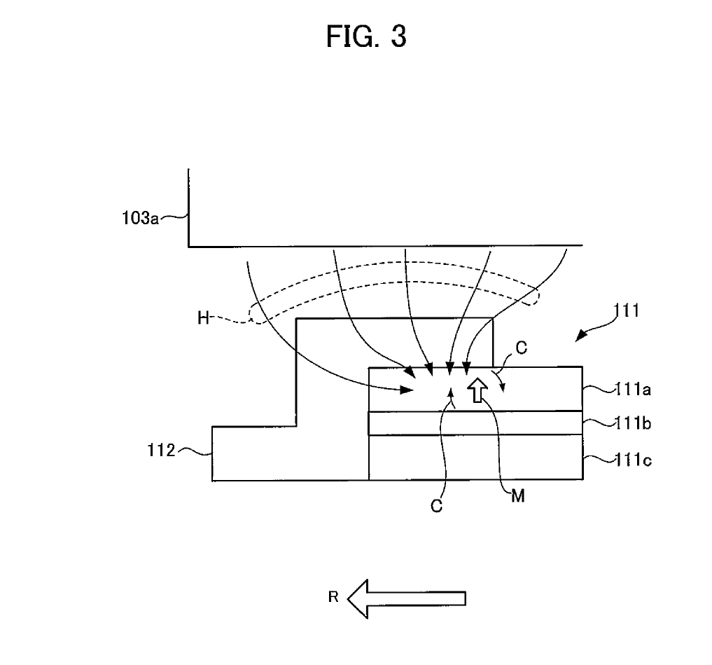

FIG. 3 is a schematic diagram of a state in which magnetic lines of force of a magnetic field applied by the recording head are absorbed by the soft high-permeability magnetic film.

In FIG. 3, a sectional view of the recording bit 111 and the soft high-permeability magnetic film 112 illustrated in FIG. 2 as well and a recording head 103a mounted on the head gimbal assembly 103 illustrated in FIG. 1 are illustrated. In a state illustrated in FIG. 3, magnetization M held upward in FIG. 3 in the recording layer 111a of the recording bit 111 is reversed downward by a magnetic field applied by the recording head 103a, whereby information is recorded in the recording layer 111a. The recording head 103a is an example of the recording head in the basic mode of the information recording device.

As illustrated in FIG. 3, magnetic lines of force H of the magnetic field applied by the recording head 103a are absorbed by the soft high-permeability magnetic film 112 having high magnetic permeability. As a result, a part of the magnetic lines of force H that are expected to pass the front in the traveling direction of the recording bit 111 indicated by the arrow R are absorbed by the soft high-permeability magnetic film 112 and pass through the recording layer 111a. In other words, in this embodiment, when magnetization is reversed and new information is recorded, the number of the magnetic lines of force H that pass through the recording layer 111a is large.

The example illustrated in FIG. 3 is an example in which information is recorded in the recording layer 111a, in which the magnetization M is held upward in FIG. 3 as explained above, by reversing the magnetization M downward with the magnetic field from the recording head 103a. In this embodiment, in order to realize strong resistance against thermal fluctuation, a magnetic material that has strong magnetic anisotropy and may need a large magnetic field for reversal of magnetization is used as a hard magnetic material forming the recording layer 111a. Therefore, as in the example illustrated in FIG. 3, when the magnetization is reversed and information is recorded, if a magnetic field in the recording layer 111a is weak, it is likely that a write error causing a failure in reversal of the magnetism M occurs. However, in this embodiment, since the number of the magnetic lines of force H passing through the recording layer 111a is large as explained above, a magnetic field contributing to reversal of the magnetization M in the recording layer 111a is strong. The occurrence of the write error causing a failure in reversal of the magnetization M is suppressed.

The magnetic lines of force H absorbed by the soft high-permeability magnetic film 112 as explained above pass through the recording layer 111a obliquely to the magnetization M facing the direction perpendicular to the disk substrate 113. The magnetic lines of force H that pass obliquely to the magnetization M in this way act to push the magnetization M in a direction parallel to the disk substrate 113 and reverse the magnetization M as indicated by an arrow C in FIG. 3. Therefore, an effect of reversing the magnetization M is large.

As explained above, in this embodiment, the magnetization M in the recording layer 111a is easily reversed by the effect of absorption of the magnetic lines of force H by the soft high-permeability magnetic film 112 as well as the passing direction of the absorbed magnetic lines of force H.

TABLE 1

| | Strength of reversal |
|---|---|
| | magnetic field (Oe) |
| With soft high-permeability | 10494 (131.9 A/m) |
| magnetic film | |
| Without soft high-permeability | 8099 (101.8 A/m) |
| magnetic film | |

Table 1 is a table in which easiness of reversal of the magnetization M of the recording bit 111 in this embodiment covered with the soft high-permeability magnetic film 112 is indicated by a magnitude of a magnetic field (a reversal magnetic field) that the recording head 103a may need to reverse the magnetism M of the recording bit 111. In Table 1, for comparison, the strength of a reversal magnetic field for a recording bit in the past not covered with a soft high-permeability magnetic film is illustrated.

As illustrated in Table 1, whereas the reversal magnetic field of the recording bit in the past is 10494 Oe (131.9 A/m), the reversal magnetic field of the recording bit 111 in this embodiment is 8099 Oe (101.8 A/m). It is seen that it is easy to reverse the magnetism M in the recording bit 111 in this embodiment. This is because, as explained above, a magnetic field that does not contribute to reversal of magnetization in the recording bit in the past contributes to reversal of the magnetism M in the recording bit 111 in this embodiment.

In this embodiment, the application of the magnetic field by the recording head 103a to the recording bit 111 as a recording target is executed at timing within a range after the information-recorded recording bit 111 sufficiently leaves the recording head 103a until the recording bit 111 as the recording target passes right below the recording head 103a to a certain extent as explained below.

If magnetic lines of force are not absorbed by the soft high-permeability magnetic film 112, when the application of the magnetic field is performed at timing when the recording bit 111 passes right below the recording head 103a, the strength of the magnetic field in the recording layer 111a is insufficient. It is highly likely that the write error occurs. However, in this embodiment, even if the application of the magnetic field is applied to a certain extent at the timing when the recording bit 111 passes right below the recording head 103a, the magnetic lines of force H are led, by the effect of absorption of the magnetic lines of force H by the soft high-permeability magnetic film 112, to a portion where the magnetic lines of force H are not expected to pass in the recording layer 111a. Consequently, a magnetic field contributing to reversal of the magnetization M is secured in the recording layer 111a and the occurrence of the write error causing a failure in reversal of the magnetization M is suppressed. This means that a range of timing in which the magnetic field can be applied is extended because of the effect of absorption of the magnetic lines of force.

In this embodiment, the soft high-permeability magnetic film 112 covers the edge and the side of the recording bit 111 only on the front side in the traveling direction indicated by the arrow R. A rear side in the traveling direction in the recording bit 111 is opened. If an edge and a side is covered with the soft high-permeability magnetic film 112 on the rear side as well, the information-recorded recording bit 111 tends to be affected by a magnetic field during information recording in the next recording bit 111 because of the effect of absorption of the magnetic lines of force H by the soft high-permeability magnetic film 112 on the rear side. In this case, the application of the magnetic field by the recording head 103a may not be performed until the information-recorded recording bit 111 escapes from the influence intensified by the effect of absorption of the magnetic lines of force H and sufficiently leaves the recording head 103a. This means that the range of the timing when the application of the magnetic field can be performed is reduced because of the effect of absorption of the magnetic lines of force H on the rear side.

On the other hand, in this embodiment, as explained above, since the rear side in the traveling direction in the recording bit 111 is opened, the reduction in the range of the timing when the application of the magnetic field can be performed does not occur. Only the extension of the range based on the effect of absorption of the magnetic lines of force H on the front side in the traveling direction explained above is realized. As a result, in this embodiment, occurrence of a delay in the application timing of the magnetic field, which induces a write error due to insufficiency of the strength of the magnetic field, is effectively suppressed.

This means that an application mode “the high-permeability magnetic film is placed on the edge on the front side in the traveling direction in a state in which an edge on a rear side in the traveling direction is opened” is preferable to the basic mode.

The soft high-permeability magnetic film 112 in this embodiment is an example of the high-permeability magnetic film in this application mode as well.

In this embodiment, as illustrated in FIGS. 1A, 2A and 2B, the width orthogonal to the rotating direction of the magnetic disk 110 indicated by the arrow R in the soft high-permeability magnetic film 112 is smaller than the width of the recording bit 111. Therefore, the effect of absorption of the magnetic lines of force by the soft high-permeability magnetic film 112 is large in the traveling direction of the recording bit 111 indicated by the arrow R but is small in a width direction orthogonal to the traveling direction.

A part of the magnetic fields applied by the recording head 103a during recording of information leaks in the direction of the recording bit 111 adjacent to the recording bit 111 as the recording target in the width direction. When the leakage magnetic field in the width direction acts on the adjacent recording bit 111 too strong, it is likely that information recorded in the adjacent recording bit 111 is rewritten. However, in this embodiment, the recording layer 111a is formed of a magnetic material having high magnetic anisotropy and originally has resistance against magnetic disturbance. Further, since the effect of absorption of the magnetic lines of force by the soft high-permeability magnetic film 112 is small in the width direction as explained above, the leakage magnetic field is prevented from, for example, being led to the recording layer 111a by the soft high-permeability magnetic film 112. Consequently, in this embodiment, occurrence of deficiencies such as the rewriting of information by the leakage magnetic field is effectively suppressed.

Therefore, an application mode “a width of the high-permeability film is narrower than a width of the information recording members in a direction crossing the traveling direction” is also preferable to the basic mode.

The soft high-permeability magnetic film 112 in this embodiment is an example of the high-permeability film in this application mode as well.

A method of manufacturing the magnetic disk 110 in this embodiment is explained below.

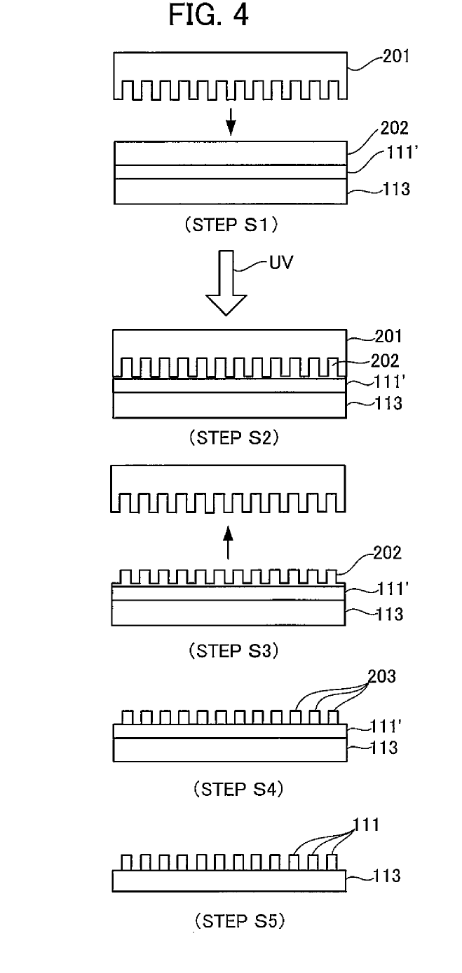

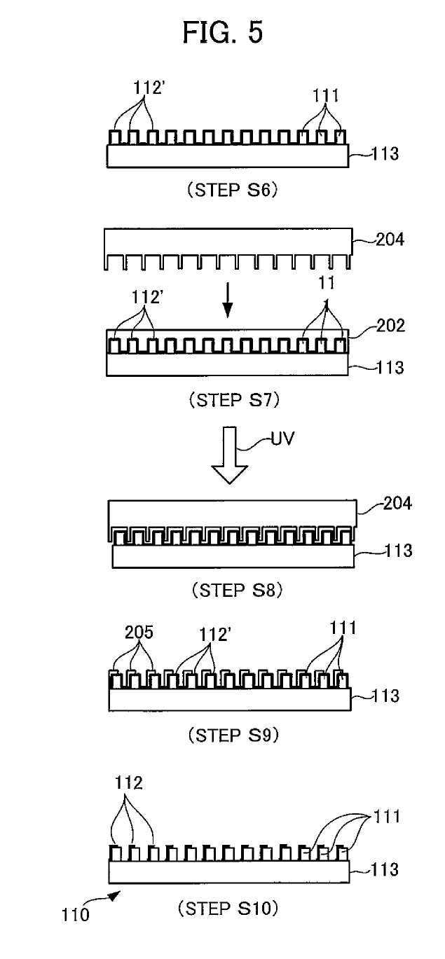

FIG. 4 is a diagram of a series of work from step S1 to step S5 of the method of manufacturing the magnetic disk. FIG. 5 is a diagram of a series of work from step S6 to step S10 of the method of manufacturing the magnetic disk.

In step S1 in FIG. 4, first, a film of a soft magnetic material having the thickness of 50 nm, a film of a nonmagnetic material having the thickness of 10 nm, and a film of a CO alloy as a hard magnetic material having the thickness of 15 nm are sequentially stacked and a three-layer film 111′ as a source of the recording bit 111 is formed by the sputtering method on the surface of the disk substrate 113 formed of glass as a nonmagnetic material. Further, in step S1, photo-curing resin 202 that hardens with ultraviolet ray irradiation is applied to the surface of the three-layer film 111′ and a first mold 201 having a convexo-concave structure in nanometer order corresponding to an array of the recording bits 111 is prepared.

Following the work in step S1, the first mold 201 is pressed against the photo-curing resin 202 in an uncured state with the convexo-concave structure faced down and curing treatment by the irradiation of an ultraviolet ray UV is applied to the photo-curing resin 202 (step S2). After the curing of the photo-curing resin 202, the first mold 202 is peeled off, whereby the convexo-concave structure in nanometer order of the first mold 201 is copied to the photo-curing resin 202 (step S3). Subsequently, a thin film in a concave portion of the convexo-concave structure of the photo-curing resin 202 is removed by reactive ion etching (step S4). Consequently, a first mask 203 as a mask for the recording bit 111 that covers only the surface of a portion left as the recording bit 111 of the three-layer film 111′ is completed.

When the first mask 203 for the recording bit 111 is completed in this way, a portion not covered with the first mask 203 of the three-layer film 111′ is removed by dry etching. Consequently, an array of the recording bits 111 including the soft magnetic backing layer 111c, the intermediate layer 111b, and the recording layer 111a illustrated in FIGS. 2 and 3 is formed on the disk substrate 113 (step S5).

Following the work in step S5, in step S6 in FIG. 5, a film (an NiFe film) 112′ having the thickness of 7 nm made of NiFe as a soft magnetic material having magnetic permeability higher than that of the recording bit 111 is formed on the surface of the disk substrate 113, on which the array of the recording bits 111 is formed, by the sputtering method.

In work in the following step S7, the photo-curing resin 202 is applied to the surface of the disk substrate 113 covered with the NiFe film 112′ and a second mold 204 having a convexo-concave structure corresponding to a shape of the soft high-permeability magnetic film 112 formed on the respective recording bits 111 is prepared.

The second mold 204 is pressed against the photo-curing resin 202 in an uncured state with the convexo-concave structure faced down and curing treatment by irradiation of an ultraviolet ray UV is applied to the photo-curing resin 202 (step S8). After the curing of the photo-curing resin 202, the second mold 204 is peeled off, whereby the convexo-concave structure of the second mold 204 is copied to the photo-curing resin 202. Further, a thin film of the photo-curing resin 202 covering a portion other than a portion left as the soft high-permeability magnetic film 112 of the NiFe film 112′ is removed by reactive ion etching. Consequently, a second mask 205 as a mask for the soft high-permeability magnetic film 112 that covers only the surface of the portion left as the soft high-permeability magnetic film 112 is completed (step S9).

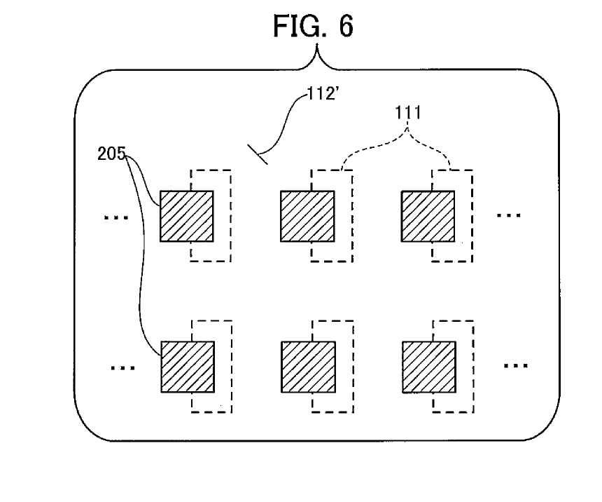

FIG. 6 is a diagram of a state in which the second mask is formed on the surface of the disk substrate covered with the NiFe film.

In FIG. 6, the second mask 205 that covers only the surface of the portion left as the soft high-permeability magnetic film 112 illustrated in FIG. 1B of the NiFe film 112′, which covers the entire surface of both the recording bits 111 and the disk substrate 113 as indicated by steps S6 to S9 in FIG. 5, is illustrated as a top view same as that in FIG. 1B.

When the second mask 205 illustrated in FIG. 6 is formed by the work in step S9 in FIG. 5, the portion not covered with the second mask 205 of the NiFe film 112′ is removed by dry etching. Consequently, an array of the recording bits 111 with the soft high-permeability magnetic film 112 is formed on the disk substrate 113 and a basic structure in the magnetic disk 110 is completed (step S10).

After step S10, until the magnetic disk 110 is finally completed, for example, processing for filling gaps among the recording bits 111 attached with the soft high-permeability magnetic film 112 with a predetermined nonmagnetic material and smoothening the surface is performed. However, since this processing is generally performed in the method of manufacturing patterned media, explanation of the processing is omitted.

In the above explanation, as an example of the substrate in the basic mode, the disk substrate 113 made of glass is illustrated. However, the substrate in the basic mode is not limited to this. The substrate may be made of, for example, aluminum, may be made of silicon, or may be made of ceramic.

In the above explanation, as an example of the recording layer in the application mode, the recording layer 111a made of the Co alloy is illustrated. However, the recording layer in the application mode is not limited to this. The recording layer may be formed of an alloy containing any of Co, Fe, Ni, Pt, Cr, B, Ti, and Ta.

According to the basic mode of the information recording device, it is possible to surely record information using the magnetic recording medium in which the occurrence of a write error is suppressed as explained above.

As explained above, according to the present invention, it is possible to obtain a bit patterned medium (a magnetic recording medium) in which the occurrence of a write error is suppressed and an information recording device that records information using such a magnetic recording medium.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although this embodiment(s) of the present invention(s) has (have) been described in detail, it should be understood that the various changes, substitutions, and alterations could be made hereto without departing from the spirit and scope of the invention.

What is claimed is:

1. A magnetic recording medium comprising:
a substrate;
plural information recording members that are formed of a hard magnetic material on the substrate, in each of which magnetization in a direction crossing the substrate is generated and, when the information recording members pass in a predetermined traveling direction in a magnetic field for information recording, the magnetization is directed to a direction corresponding to a direction of the magnetic field and information is recorded; and
a high-permeability film that is placed on an edge on a front side of the information recording members in the traveling direction and has a magnetic permeability higher than a magnetic permeability of the information recording members.

2. The magnetic recording medium according to claim 1, wherein the high-permeability magnetic film is formed of a soft magnetic material.

3. The magnetic recording medium according to claim 1, wherein a width of the high-permeability film is narrower than a width of the information recording members in a direction crossing the traveling direction.

4. The magnetic recording medium according to claim 1, wherein a side surface on the front side of the information recording members in the traveling direction is also covered with the high-permeability magnetic film.

5. The magnetic recording medium according to claim 1, wherein the information recording members have a recording layer formed of an alloy containing any of Co, Fe, Ni, Pt, Cr, B, Ti, and Ta.

6. The magnetic recording medium according to claim 1, wherein the high-permeability magnetic film is placed on the edge on the front side in the traveling direction in a state in which an edge on a rear side in the traveling direction is opened.

7. An information recording device, comprising:
a recording head that applies a magnetic field for information recording; and
a magnetic recording medium, comprising:
a substrate;
plural information recording members that are formed of a hard magnetic material on the substrate, in each of which magnetization in a direction crossing the substrate is generated and, when the information recording members pass in a predetermined traveling direction in a magnetic field for information recording, the magnetization is directed to a direction corresponding to a direction of the magnetic field and information is recorded; and
a high-permeability film that is placed on an edge on a front side of the information recording members in the traveling direction and has a magnetic permeability higher than a magnetic permeability of the information recording members.
